(19) United States
(12) Patent Application Publication
(10) Pub. No.: US 2025/0052702 A1
(43) Pub. Date: Feb. 13, 2025

(54) SECURITY INSPECTION SYSTEM AND SECURITY INSPECTION METHOD

(71) Applicant: HÖRMANN KLATT CONVEYORS GMBH, Neumarkt a. Wallersee (AT)

(72) Inventor: Peter Klatt, Neumarkt a. Wallersee (AT)

(21) Appl. No.: 18/709,101

(22) PCT Filed: Nov. 11, 2022
(86) PCT No.: PCT/EP2022/081613

§ 371 Date: Jul. 11, 2024

(30) Foreign Application Priority Data
Nov. 12, 2021 (DE) 10 2021 129 502.5

(51) Int. Cl. G01N 23/10; B65G 47/48; G01N 23/046

(52) U.S. Cl. CPC G01N 23/10; B65G 47/485; G01N 23/046; B65G 2201/0264; G01N 2223/643

(57) ABSTRACT

The invention relates to a follow-up inspection region of a security inspection system, comprising at least one follow-up inspection station accessible from two sides for the manual follow-up inspection of luggage objected to in a luggage inspection station, said manual follow-up inspection being conducted by an employee of the security inspection system in the presence of the person to whom the luggage belongs, wherein the follow-up inspection region comprises at least one removal station associated with the follow-up inspection station, for the emptying of the load carrier by the person to whom the luggage belongs, and wherein the follow-up inspection region comprises a transfer system for the automated transfer of the load carrier laden with luggage to the follow-up inspection station and from the follow-up inspection station to the associated removal station, the transfer system being designed to transfer a load carrier to the follow-up inspection station irrespective of whether the associated removal station is occupied by a load carrier.

The invention relates to a security inspection system and a security inspection method for inspecting a person's luggage.

The security inspection of persons, in particular passengers and their hand luggage, is an integral part of every flight. Whether within Europe or internationally, the procedures and also the appearance of the associated equipment have developed only marginally over the last few decades, which is not least due to the official requirements, according to which the equipment to be used and the procedures to be followed are specified. In recent years, however, innovations have been considered and the use of more modern technologies, such as the use of computer tomography to produce images for hand luggage inspection, has been gradually approved.

Due to the increasing number of air passengers, airport operators have an increased interest in increasing the efficiency of security inspections and reducing personnel costs through automation and monitoring of processes.

EP 2 684 166 B1 proposes an automated passenger inspection system for this purpose, in which passengers deposit their luggage into a load carrier at a luggage drop-off region, wherein a personal identifier of the passenger is detected and linked to the load carrier. While the luggage undergoes an imaging luggage inspection, the passengers undergo a personal inspection. Passengers then go to a luggage pick-up region, where the load carrier linked to their personal identifier is made available for emptying.

WO 2020/249192 A1 also discloses an automated security inspection system which provides an inspection device after the luggage pick-up region which is designed to determine the loading state and the degree of soiling of a load carrier.

The invention is based on the object of increasing the efficiency of security inspections, especially in the follow-up inspection region.

According to the invention, this object is achieved by the features of claims 1 and 15.

The security inspection system according to the invention essentially consists of
a luggage drop-off region with at least one drop-off station for dropping off a person's luggage into at least one load carrier,
a luggage inspection station for imaging examination of the luggage,
a luggage pick-up region for luggage not objected to at the luggage inspection station,
a follow-up inspection region with at least one follow-up inspection station accessible from two sides for manual follow-up inspection of luggage objected to at the luggage inspection station by an employee of the security inspection system in the presence of the person to whom the luggage belongs, wherein the follow-up inspection region has at least one removal station associated with the follow-up inspection station for emptying the load carrier by the person to whom the luggage belongs, and
   the follow-up inspection region has at least one transfer system for the automated transfer of the load carrier laden with luggage to the follow-up inspection station and from the follow-up inspection station to the associated removal station, wherein the transfer system is designed to transfer a load carrier to the follow-up inspection station irrespective of whether the associated removal station is occupied by a load carrier, and
a transport system for transporting the load carriers laden with luggage from the luggage drop-off region via the luggage inspection station to the luggage pick-up region or to the follow-up inspection region and for returning empty load carriers to the luggage drop-off region.

The security inspection method according to the invention is characterized in that
a person in a luggage drop-off region with one or more drop-off stations drops his or her luggage into a load carrier provided at a drop-off station,
the luggage is subjected to imaging examination at a luggage inspection station,
the person collects his/her luggage in a luggage pick-up region with one or more removal stations, provided that the luggage was not objected to at the luggage inspection station,
the person proceeds to a follow-up inspection region with at least one follow-up inspection station accessible from two sides for manual inspection, if the luggage was objected to at the luggage inspection station, wherein the follow-up inspection station is accessible on one side by an employee of the security inspection system and on the other side by the person to whom the luggage objected to belongs,
the load carriers laden with luggage are transported from the luggage drop-off region via the luggage inspection station to the luggage pick-up region or to the follow-up inspection region and empty load carriers are transported back to the luggage drop-off region,
   wherein
after the manual inspection of the luggage, the person goes from the follow-up inspection station to an assigned removal station to empty the load carrier and
the person's load carrier laden with luggage is transferred in automated fashion from the follow-up inspection station to the assigned removal station, wherein the transfer of a new load carrier laden with luggage to the follow-up inspection station takes place irrespective of whether the assigned removal station is occupied with a load carrier.

In conventional systems, luggage objected to is usually examined at a separate table by a security inspection system employee in the presence of the person to whom the luggage belongs. Since computer tomographs are already being widely used for luggage inspection today, and could examine a significantly larger volume of luggage in one load carrier, correspondingly large load carriers will be used in the future. However, this will mean that such load carriers can no longer be carried, and the person would have to clear or empty the load carrier on site at the same table after a follow-up inspection has been carried out. The security personnel would then have to wait until the person has removed all items from the load carrier before the next follow-up inspection could take place.

According to the invention, the processes “follow-up inspection” and “removal” are now spatially separated from one another by providing a follow-up inspection station and at least one associated removal station, so that the security personnel can already carry out the next follow-up inspection while the previous person is still emptying their load carrier. A suitably designed transfer system is therefore also provided for the transfer of the load carrier to the follow-up inspection station and between the follow-up inspection station and the removal station. Of course, in principle it is also possible for the person or passenger to unload the load carrier directly at the follow-up inspection station if there is either not much luggage or the assigned removal station is still blocked by the previous person.

Further embodiments of the invention are the subject matter of the dependent claims.

According to one embodiment of the invention, there is a first sojourn region for the security inspection system employee behind the follow-up inspection station and a second sojourn region in front of it for the persons whose luggage is to be inspected. Furthermore, from the associated removal station a third sojourn region is provided for the person emptying the load carrier. The three sojourn regions are sized such that at least one employee or person can be in each of them at the same time. Ideally, the follow-up inspection and removal regions are separated from each other by suitable means, such as separating walls, to ensure privacy.

The load carrier is made available at the follow-up inspection station between the first and second sojourn locations, wherein a transparent security partition, which can preferably be raised and lowered, can be provided between the load carrier and the second sojourn region for the persons whose luggage is to be inspected. In this way, the person is able to observe the luggage inspection, but an activated security barrier can also prevent the person from disrupting the follow-up inspection by manually intervening.

Furthermore, the follow-up inspection region can have at least one buffer system for the temporary storage of load carriers laden with luggage, wherein a transfer system is designed to transfer the load carriers laden with luggage temporarily stored in the buffer system to the follow-up inspection station. The buffer system could have at least two buffer areas and is preferably designed to re-sort the load carriers laden with luggage so that the order of the follow-up inspection is linked to the arrival of the persons in the follow-up inspection region and not to the order in which the luggage enters the buffer system. The re-sorting of the load carriers can be carried out, for example, by moving them in at least two different, in particular orthogonal, axial directions.

According to a preferred embodiment of the invention, a first identification device for detecting a personal identifier, in particular biometric features, of the person is provided in each drop-off station, which first identification device cooperates with a data processing device for linking the personal identifier of the person with the load carrier in which the person's luggage is located. At each drop-off station, a personal identifier of the person can thus be detected by means of the first identification device, wherein the personal identifier of the person is linked by means of the data processing device to the load carrier in which the person's luggage is located. If a person requires multiple load carriers, these will also be linked to the person's personal identifier.

In this way, the load carriers laden with the luggage are clearly assigned to the person to whom the luggage belongs. The first identification device can either be designed to detect the person's personal identifier for the first time or it can be used to identify the person if the personal identifier is already stored in the system. For example, a person's personal identifier could be detected when entering the airport building or when dropping off large luggage. It is also conceivable for the person to generate their own personal identifier in advance of a trip, for example using a smartphone, and to upload it to the airline. In addition to the person's biometric characteristics, other personal identifiers, such as a code on the boarding pass, would also be conceivable. However, biometric features have the advantage that they can be easily captured with a camera, eliminating the need to scan the boarding pass or some other token.

In a special embodiment of the load carrier, it can be designed so that it can be closed with a cover, wherein devices can be provided at the drop-off stations, the removal stations, the follow-up inspection stations, and the removal stations which cause the covers to be automatically lifted off and placed on the load carriers.

After dropping off the luggage, the person goes to the personal security inspection, which can be carried out in the generally known manner. At the same time, the luggage is subjected to an imaging examination in the luggage inspection station. After the personal inspection, the person receives information at an information kiosk as to whether he or she should go to the general luggage pick-up region or to the follow-up inspection region, depending on the result of the luggage inspection.

In order to ensure that the correct load carrier is provided in the luggage pick-up region, the at least one follow-up inspection station is equipped with a third identification device for detecting the personal identifier of the person standing at the follow-up inspection station, wherein the third identification device is linked to the transfer system in order to transfer the load carrier linked to the person's personal identifier to this follow-up inspection station. This can prevent the person from accidentally looking into another person's luggage. If this person has dropped off a plurality of load carriers, all of this person's load carriers can be transferred to the follow-up inspection area, although it may be appropriate if only the load carrier that is actually objected to is then made available at the follow-up inspection location.

In an optional embodiment, the follow-up inspection region can have at least two follow-up inspection stations, each with at least one associated removal station, and the transfer system can be designed to transfer load carriers laden with luggage from the buffer system to the at least two follow-up inspection stations. This has the advantage that in a follow-up inspection region with a plurality of follow-up inspection stations, a person can go to the next free follow-up inspection station and the correct load carrier is provided after the person's personal identifier has been identified.

The follow-up inspection region can also include a waiting area for persons whose luggage has been objected to at the luggage inspection station. For example, a light and/or sound signal can indicate to the next person in the waiting area that they can go to a follow-up inspection station that has become free.

In order to completely remove the luggage, the load carrier and, if appropriate, the person's further load carriers not objected to, is transferred to a removal station assigned to the follow-up inspection station, which is expediently located in close proximity. In order to ensure that the correct load carrier is also provided there, the at least one removal station can optionally be equipped with a fourth identification device for detecting the personal identifier of the person standing at the removal station, wherein the fourth identification device is linked to the transfer system in order to transfer the load carrier linked to the person's personal identifier from the follow-up inspection station to this removal station.

In order to complete the removal process automatically, a sensor unit, which is formed for example by the fourth identification device, can be provided at each removal station, which unit is designed to determine the presence of a person at the removal station and which unit is linked to the monitoring device and the transfer system in such a way that the emptying process is completed by removing the emptied load carrier if the sensor unit does not detect a person in front of the removal station and the load carrier is empty.

Of course, it would also be conceivable that after emptying the load carrier at the removal station, the person completes the emptying process by entering something at an input unit and the load carrier is then transported away. In this case, however, automated transporting away would also have to be provided if the person leaves the removal station without completing the process by entering data.

The monitoring device at the removal station can preferably also be designed to detect a load carrier that is not completely emptied and/or is soiled, wherein the transport system is then also designed to eject load carriers that are not completely emptied and/or are soiled. Preferably, however, the person is made aware in good time by suitable acoustic or visual signals that there are still objects in the load carrier.

Further embodiments and advantages of the invention are explained in more detail with reference to the following description and the drawings.

In the drawings:

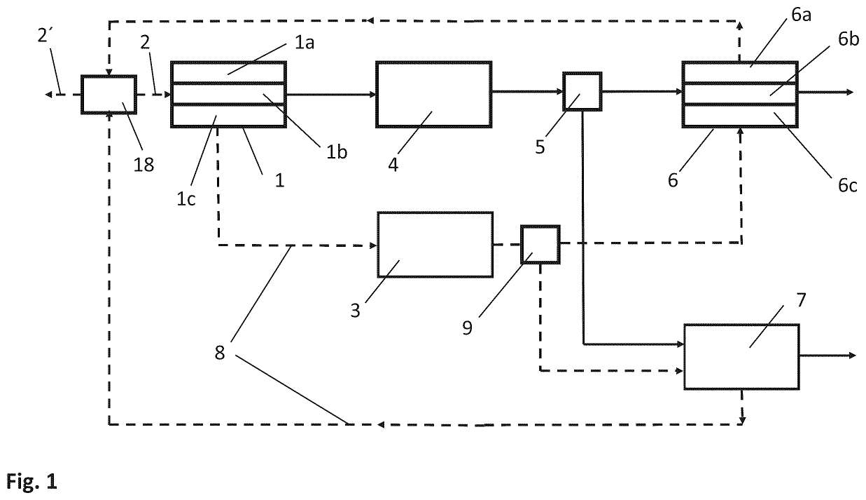

FIG. 1 is a block diagram of the security inspection system,

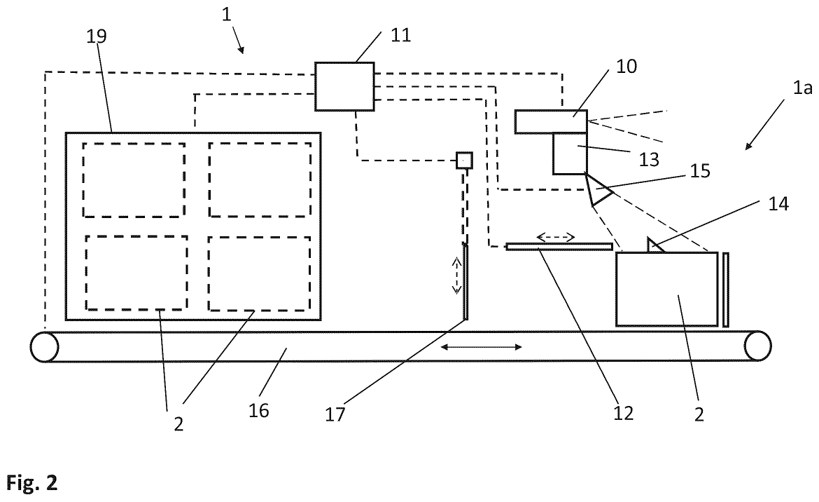

FIG. 2 is a schematic view of the luggage drop-off region with a drop-off station,

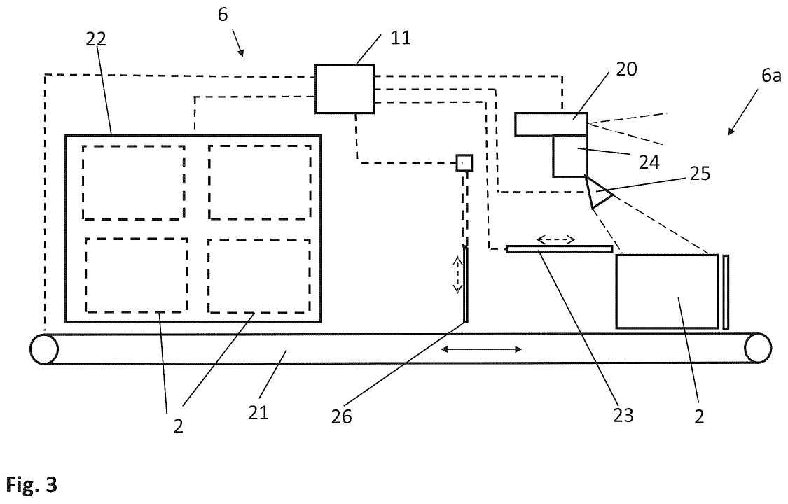

FIG. 3 is a schematic view of the luggage pick-up region with a removal station,

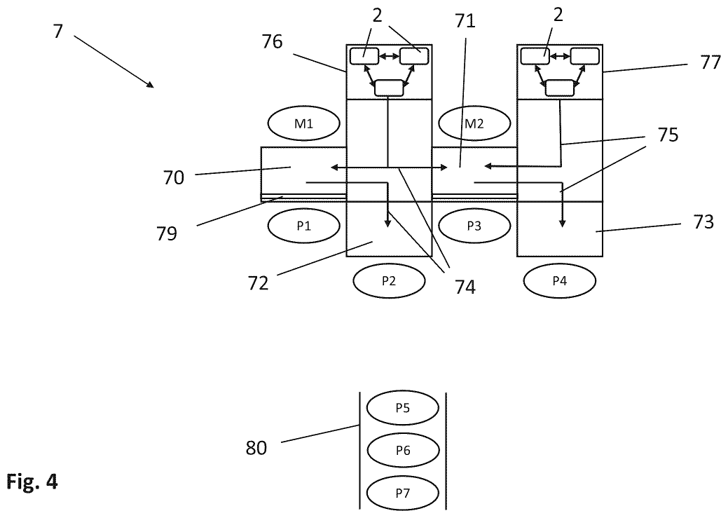

FIG. 4 is a schematic plan view of the follow-up inspection region according to a first embodiment,

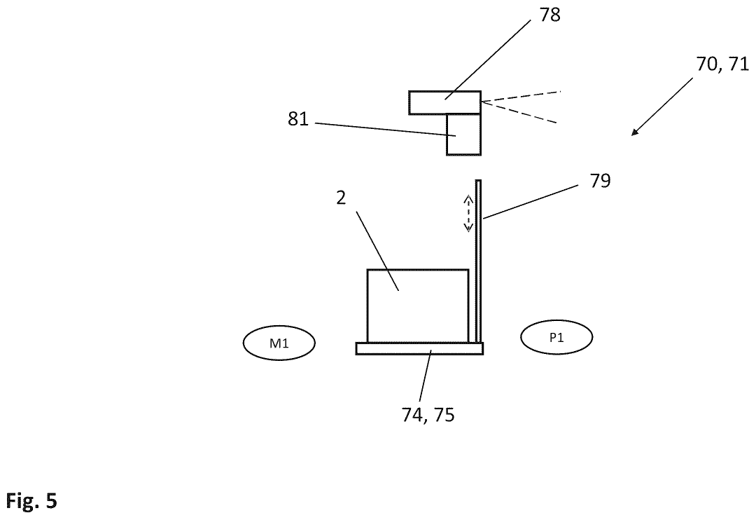

FIG. 5 is a schematic view of a follow-up inspection station,

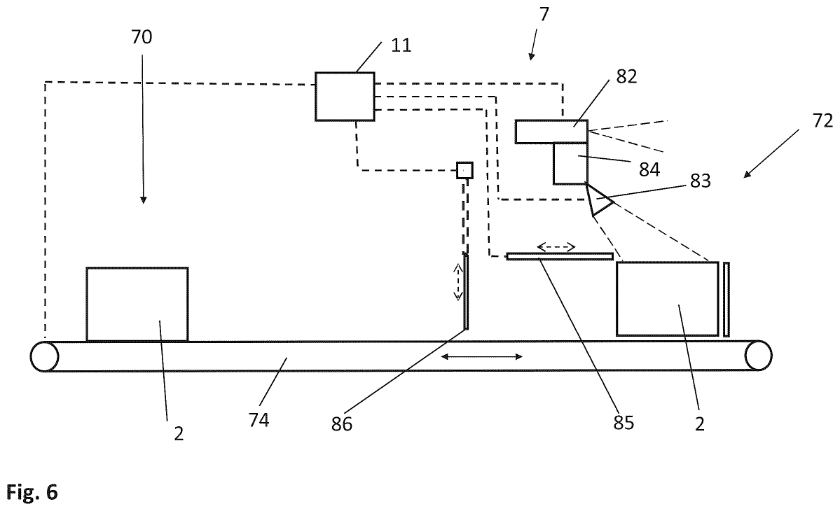

FIG. 6 is a schematic view of a removal station,

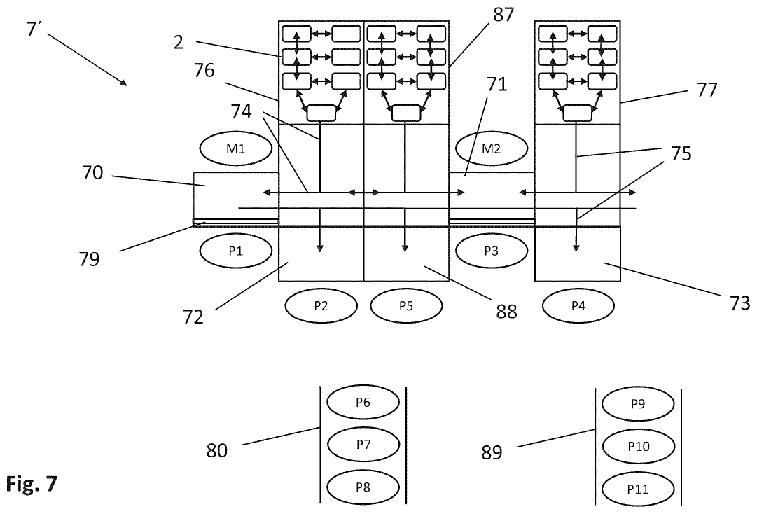

FIG. 7 is a schematic plan view of the follow-up inspection region according to a second embodiment and

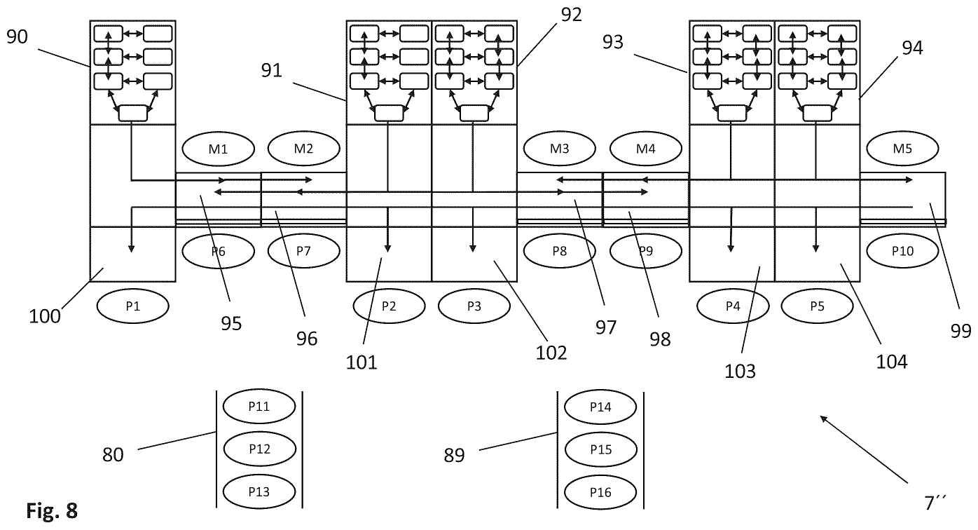

FIG. 8 is a schematic plan view of the follow-up inspection region according to a third embodiment.

FIG. 1 shows an embodiment of a security inspection system represented as a block diagram. It provides a luggage drop-off region 1 with one or more drop-off stations 1a, 1b, 1c for dropping luggage off into a load carrier 2. The load carrier 2 laden with luggage is fed to a luggage inspection station 3 for imaging examination of the luggage, wherein a computer tomograph is preferably used there.

During the luggage inspection, the person goes to a person inspection station 4. For example, metal detectors and body scan devices as well as other devices can be used here.

The person inspection station 4 preferably has queuing and route systems that can control synchronization between luggage status and inspection of persons in a targeted manner. Thus, after the personal inspection has been completed, the person receives information at an information device 5 as to whether he or she should go to a luggage pick-up region 6 with one or more removal stations 6a, 6b, 6c to receive and empty the load carrier assigned to the person or to a follow-up inspection region 7 for manual follow-up inspection of his or her luggage. The routes for persons are illustrated in FIG. 1 with solid arrows.

Dashed arrows indicate a transport system 8 for transporting the load carriers 2 from the luggage drop-off region 1 via the luggage inspection station 3 to the luggage pick-up region 6 or to the follow-up inspection region 7 and for returning empty load carriers to the luggage drop-off region 1. After the luggage inspection station 3, a switch 9 is provided to divert the luggage objected to in the luggage inspection station 3 to the follow-up inspection region 7. By the time the switch is reached, the operator of the luggage inspection station (CT device) has to have made the decision as to whether a follow-up inspection is necessary. If a decision is not made in time, the load carrier 2 is automatically sent to the follow-up inspection region 7, so that there is no mixing of objected-to and non-objected-to pieces of luggage on the route to the luggage pick-up region 6.

In the region of the return transport route, a device 18 is provided for ejecting load carriers 2′ that are not completely emptied and/or are soiled.

With reference to FIG. 2, the luggage drop-off region 1 is described in more detail below using the example of the drop-off station 1a. Thus, the drop-off station 1a has a first identification device 10 for detecting a personal identifier (in particular biometric features) of the person, which is preferably designed as a camera. The personal identifier of the person is linked to the load carrier 2 provided at the drop-off station 1a by means of a data processing device 11, in which an identifier attached to the load carrier 2 is read out with a reading device (not shown in detail) and linked to the personal identifier of the person. The identifier on the load carrier 2 can be formed, for example, by an RFID, a QR code, or a similar marking.

As soon as the person's personal identifier is detected, a cover 12 opens, releasing the load carrier for loading. In the illustrated embodiment, the load carrier 2 is box-shaped and open at the top. The person can then stow his/her luggage in the load carrier 2, wherein visual and/or acoustic instructions can be given to the person via a first information device 13, which in particular comprises a monitor and a loudspeaker. In particular, in this way it can be pointed out that a specified maximum load limit is not to be exceeded. For this purpose, the load carrier 2 can have a corresponding marking. However, it is also conceivable that the load carrier 2 may be laden in such a way that the luggage 14 does not protrude beyond the dimensions of the load carrier 2.

A first monitoring device 15, which is formed by a camera, for example, detects the loading state of the load carrier 2, wherein in the event of an undesirable loading state, a corresponding indication is given via the first information device 13. Since in the example shown the luggage 14 protrudes beyond the dimensions of the load carrier 2, the person could be asked to place the luggage correctly or to request a second load carrier. There is also the option to request help from an employee if a person is having trouble complying.

If the luggage is properly stowed in the load carrier 2, the luggage drop-off process can be completed in automated fashion by an inspection, in particular after a specified time, showing that there is no longer a person at the drop-off station 1a, so that an automated transporting away of the load carrier 2 can be initiated. However, it could also be provided that the person closes the load carrier with a cover or lid. Alternatively, the closing could be completed by pressing a button or in a similar manner. If the person leaves the removal station without confirmation, he or she may be prompted to an actuation via the first information device 13. Should the person nevertheless leave, which could possibly be prevented by a blockable exit, an automatic transporting away can be initiated after a specified time has elapsed.

For the transporting away, the cover 12 first closes and/or a gate 17 opens to allow the load carrier 2 to be transported away. The transport of the load carrier 2 takes place via the transport system 8 and/or a provision system 16 connected to the transport system 8, wherein the first monitoring device 15 is coupled to the provision system 16 and/or the transport system 8 in such a way that the transporting away of the load carrier 2 from the drop-off station 1a is blocked (gate 17 remains closed) if an undesirable loading state of the load carrier 2 is detected. The load carrier 2 laden with luggage is then supplied to the luggage inspection station 3 via the transport system 8, while the person goes to the person inspection station 4.

The drop-off station 1a is assigned a buffer region 19 for returned, empty load carriers 2, wherein in the drop-off station 1c the next empty load carrier is provided via the transport system 8 or the provision system 16.

In the following, the luggage pick-up region 6 is explained in more detail using the example of the removal station 6a, with reference to FIG. 3.

The removal station 6a can fundamentally be constructed similarly or identically to the drop-off station 1a. Thus, the removal station 6a has a second identification device 20 for detecting the personal identifier of the person standing in front of the removal station 6a, wherein the second identification unit 20 is linked to a second provision system 21 in order to transfer the load carrier 2 linked to the personal identifier of the person to this removal station 6a. For this purpose, the luggage pick-up region 6 has at least one buffer 22 for a plurality of load carriers 2 laden with luggage, wherein a plurality of the removal stations, for example the removal stations 6a, 6b, and 6c, are assigned to the buffer 22. The second provision system 21 is designed to transfer the load carriers 2 laden with luggage from the buffer 22 to one of the removal stations 6a, 6b, 6c, wherein the buffer 22—regardless of the order in which the load carriers 2 were introduced into the buffer 22—is capable of transferring the load carriers 2 to each of the associated removal stations in any order. The person who wants to pick up their luggage can therefore go to any removal station 6a, 6b, 6c that is currently free and is identified there by the second identification device 20, so that the load carrier 2 linked to his personal identifier is transferred from the buffer 22 to this removal station.

As soon as the associated load carrier 2 is provided in the removal station, a cover 23 opens, making the load carrier 2 accessible for unloading. Information can be provided to the person via an input and/or output unit 24. A second monitoring device 25, which is formed for example by a camera, detects the loading state of the load carrier 2. Via the input and/or output unit 24, the person can be made aware in particular that there are still pieces of luggage/objects in the load carrier 2. After complete removal, the passenger can be wished a good flight and/or the departure gate can be displayed for example, and it would also be conceivable to display advertising.

In an advantageous embodiment, a sensor unit is provided at the existing removal stations, which unit is formed for example by the second identification unit 20, which is designed to determine the presence of a person located in front of the removal station, and which is linked to the second monitoring unit 25 and the second provision system 21 in such a way that the emptying process is completed by removing the emptied load carrier 2 if the sensor unit does not detect a person in front of the removal station 6a and the load carrier 2 is empty. In this way, the removal station can be made available to the next person as quickly as possible.

Once the removal process is completed, the cover 23 closes and/or a gate 26 opens to allow the load carrier 2 to be transported away. The transport of the load carrier 2 takes place via the second provision system 21 and/or the transport system 8, wherein the second monitoring device 25 is coupled to the second provision system 21 and/or the transport system 8 in such a way that the removal of the load carrier 2 from the removal station 6a is blocked (gate 26 remains closed) if there is still an object in the load carrier 2. If the load carrier 2 is empty, the return transport to luggage drop-off region 1 is initiated. The next removal process can then be initiated by the detection, by the second identification device 20, of the next person standing in front of the removal station.

According to a preferred embodiment of the invention, the second monitoring device 25 in the removal stations 6a, 6b, 6c can also be able to detect soiling of the load carrier 2, for example due to a leaked liquid. Soiled load carriers could then be ejected at the device 18 (FIG. 1). Ejection could also occur in the case of a load carrier that is not, or not completely, emptied, if the person has left the removal station 6a, 6b, 6c before the emptying is complete.

If a person's luggage is objected to at the luggage inspection station 3, the person is first recognized at the information device 5 by means of his or her personal identifier and is then informed that he or she must proceed to the follow-up inspection region 7.

FIG. 4 shows a first embodiment of a follow-up inspection region 7 according to the invention, which here has a first and a second follow-up inspection station 70, 71 with a first and a second associated removal station 72, 73 for the emptying of the load carrier 2 by the person to whom the luggage belongs. The follow-up inspection region 7 further provides a first and a second transfer system 74, 75 for the automated transfer of the load carriers 2 laden with luggage to the follow-up inspection stations 70, 71 and from the follow-up inspection stations 70, 71 to the associated removal stations 72, 73, wherein the transfer systems 74, 75 are designed to transfer the load carriers 2 to the follow-up inspection station 70 or 71 irrespective of whether the associated removal station 72 or 73 is occupied by a load carrier 2. In other words, a load carrier can be transported to the follow-up inspection station 70 or 71 even if the corresponding removal station 72 or 73 is still occupied.

Behind each follow-up inspection station 70 or 71, a corresponding first sojourn region M1 or M2 is provided for security inspection employees, while in front of each luggage removal station 72 or 73, a second sojourn region P1 or P3 is provided for persons whose luggage must undergo a follow-up inspection, wherein the size of the first and second sojourn regions M1, M2 and P1, P3 are such that in each case at least one person can be there at the same time. The follow-up inspection station 70 or 71 is therefore provided between the first sojourn region M1 or M2 and the second sojourn region P1 or P3.

Furthermore, the follow-up inspection region 7 has a first and a second buffer system 76 and 77 for the temporary storage of load carriers 2 laden with luggage, wherein the transfer systems 74 and 75 are designed to transfer the load carriers 2 laden with luggage temporarily stored in the buffer systems 76 or 77 to the follow-up inspection stations 70 or 71, respectively. The buffer systems 76, 77 can each provide at least two buffer spaces for the temporary storage of load carriers 2 laden with luggage, wherein the buffer systems 76, 77 are designed to re-sort the load carriers 2 laden with luggage. In the illustrated embodiment, the first and second buffer systems 76, 77 are each designed for three load carriers 2, although a larger buffer occupancy would also be conceivable. Ideally, the buffer systems 76, 77 are designed to re-sort the load carriers by moving them in at least two different, in particular orthogonal, axial directions, so that the order of the follow-up inspection is not tied to the order in which the load carriers 2 entered one of the buffer systems 76 or 77. The persons who have to go to the follow-up inspection region can thus overtake each other and, during the follow-up inspection, are not bound by the order in which the load carriers arrive in the follow-up inspection region.

According to FIG. 5, the follow-up inspection stations 70, 71 are each equipped with a third identification device 78 for detecting the personal identifier of the person standing at the follow-up inspection station 70 or 71, wherein the third identification device 78 is linked to the transfer system 74 or 75 in order to transfer the load carrier 2 linked to the personal identifier of the person to this follow-up inspection station. The load carrier 2 with the luggage objected to is made available between the first and second sojourn locations M1, P1, so that the load carrier is located between the security inspection system employee and the person to whom the luggage objected to belongs. In order to prevent unauthorized intervention by the person during the follow-up inspection by the employee, a transparent safety partition 79, which can preferably be raised and lowered, can be provided between the second sojourn location P1 and the provided load carrier 2.

In a further embodiment of the follow-up inspection region (FIG. 4), the follow-up inspection region 7 can have at least one waiting area 80 for persons (P5-P7) until the next follow-up inspection place becomes free. Each inspection station 70, 71 could optionally provide deposit areas to assist with clearing out. In addition, for the security inspection system employee, a small X-ray machine or other equipment supporting the follow-up inspection could be available there. It might also be possible to run the entire load carrier or parts of the luggage through a computer tomograph again in automated fashion at the employee's initiation.

In the illustrated embodiment, the removal station 72 is assigned to the follow-up inspection station 70 and the removal station 73 is assigned to the follow-up inspection station 71, wherein the load carriers 2 can be transferred from the buffer 76 and preferably also from the buffer 77 to both follow-up inspection stations 70, 71. Within the scope of the invention, it is further conceivable that an employee of the security inspection region can at least at times be responsible for two follow-up inspection stations.

After the follow-up inspection, the load carrier with the person's luggage is transferred from the follow-up inspection station 70, 71 to the assigned removal station 72, 73, where it can then be emptied by the person. As a result, the person moves from the sojourn region P1 to the sojourn region P2 in front of the removal station 72 or from the sojourn region P3 to the sojourn region P4 in front of the removal station 73. In the following, the removal station is described with reference to FIG. 6 in more detail using the example of removal station 72. In principle, the removal stations 72 and 73 of the follow-up inspection region 7 can be identical or at least very similar to the removal stations 6a, 6b, 6c of the luggage pick-up region 6.

Thus, the removal station 72 is equipped with an optional fourth identification device 82 for detecting the personal identifier of the person standing at the removal station 72, wherein the fourth identification device 82 is linked to the first transfer system 74 in order to transfer the load carrier 2 linked to the person's personal identifier from the follow-up inspection station 70 to this removal station 72. At the removal station 72, a further monitoring device 83 is provided for detecting a load carrier that is not completely emptied and/or is soiled. In accordance with the pick-up stations, a sensor unit, which is formed for example by the fourth identification device 82, is also provided at each removal station 72, which unit is designed to determine the presence of a person located at the removal station 72 and which is linked to the further monitoring device 83 and the first transfer system 74 in such a way that the emptying process is completed by removing the emptied load carrier 2 if the sensor unit does not detect a person in front of the removal station and the load carrier is empty.

Furthermore, a further information device 84 can be provided in correspondence with the removal stations in order to inform the person about, for example, the loading status of the load carrier. This device could also be used for example to display the gate to which the person has to go after emptying the load carrier 2, if this information is available in the system. Furthermore, a fold-out seat could optionally be provided at the removal station 72, 73, which could for example make dressing easier.

A cover 85 for releasing the load carrier 2 and a gate 86 may also be present. The data processing device 11 in turn is used to control the process.

Ideally, the follow-up inspection region 7 is arranged adjacent to the luggage pick-up region 6, so that at least one removal station 72 or 73 can function either as a removal location or as a removal station, depending on the number of persons in the follow-up inspection region 7 and in the luggage pick-up region 6.

FIG. 7 shows a second embodiment of a follow-up inspection region 7′, in which a third buffer system 87 and a third removal station 88 are additionally provided. At the first follow-up inspection station 70, load carriers 2 can be provided from the first buffer system 76 as well as from the third buffer system 87. Preferably, load carriers 2 from the second buffer system 77 as well as from the third buffer system 87 are transferred to the second follow-up inspection station 71. Optionally, it is of course also conceivable that the load carriers from each of the three buffer systems can be transferred to each of the two follow-up inspection stations, which would provide the greatest possible flexibility. In contrast to the first embodiment according to FIG. 4, not just two but three removal stations 72, 73, 88 are assigned to the two follow-up inspection stations 70, 71, which ensures with a high degree of probability that a free removal station will be immediately available to the person after the follow-up inspection has been carried out.

If the load carriers could actually be transferred from each of the three buffer systems to each of the two follow-up inspection stations, then the one first waiting area 80 would be completely sufficient. However, since the second follow-up inspection station 71 could, depending on the design of the system, block a transfer of a load carrier 2 from the second buffer system 77 to the first follow-up inspection station 70 during a follow-up inspection currently taking place, it would be expedient to provide a second waiting area 89 for the persons whose load carriers are being introduced into the second buffer system 77. After the personal inspection, the information device 5 (FIG. 1) would then not only have to inform the person that he or she has to go to the follow-up inspection region 7′, but would also have to inform him or her which of the two waiting areas 80, 89 is intended for him or her.

In a third exemplary embodiment of a follow-up inspection region 7″ according to FIG. 8, a total of five buffer systems 90-94 with 5 follow-up inspection stations 95-99 and five removal stations 100-104 are provided, wherein the special feature consists in the fact that two follow-up inspection stations 95 and 96 or 97 and 98 are arranged directly next to each other. This has the advantage that one employee could easily operate two follow-up inspection stations if necessary.

However, the invention is not limited to the exemplary embodiments shown. Rather, further arrangements with more or fewer follow-up inspection or removal stations are conceivable. For example, it would also be possible to provide only one large buffer system that is connected to at least three, preferably all, follow-up inspection stations.

In both exemplary embodiments, the return transport of the emptied load carriers 2 can be carried out in a similar manner as in the removal stations, in that the first or second transfer system 74, 75 is connected in a suitable manner to the return transport route for the load carriers 2.

1. A security inspection system, comprising
a luggage drop-off region (1) with at least one drop-off station (1a, 1b, 1c) for dropping off a person's luggage into at least one load carrier (2),
a luggage inspection station (3) for imaging examination of the luggage,
a luggage pick-up region (6) for luggage not objected to at the luggage inspection station,
a follow-up inspection region (7) with at least one follow-up inspection station (70, 71) accessible from two sides for manual follow-up inspection of luggage objected to at the luggage inspection station by security personnel in the presence of the person to whom the luggage belongs,
a transport system (8) for transporting the load carriers (2) laden with luggage from the luggage drop-off region (1) via the luggage inspection station (3) to the luggage pick-up region (6) or to the follow-up inspection region (7) and for returning empty load carriers (2) to the luggage drop-off region (1),
characterized in that
the follow-up inspection region (7) has at least one removal station (72, 73) associated with the follow-up inspection station (70, 71) for emptying of the load carrier (2) by the person to whom the luggage belongs,
the follow-up inspection region (7) has at least one transfer system (74, 75) for transferring the load carrier (2) laden with luggage to the follow-up inspection station (70, 71) and from the follow-up inspection station (70, 71) to the associated removal station (71, 73), wherein the transfer system (74, 75) is designed to transfer a load carrier (2) to the follow-up inspection station (70, 71) irrespective of whether the associated removal station (72, 73) is occupied by a load carrier (2).

2. The security inspection system according to claim 1, characterized in that there is a first sojourn region (P1, P3) for persons in front of the follow-up inspection station (70, 71) and a second sojourn region (P2, P4) for persons in front of the removal station (72, 73), wherein the size of the first and second sojourn regions (P1-P4) is such that at least one person can stay in each of them at the same time.

3. The security inspection system according to claim 1, characterized in that the follow-up inspection region (7) has at least one buffer system (76, 77; 87) for the temporary storage of load carriers (2) laden with luggage and the transfer system (74, 75) is designed to transfer the load carriers (2) laden with luggage temporarily stored in the buffer system (76, 77; 87) to the follow-up inspection station (70, 71).

4. The security inspection system according to claim 3, characterized in that the buffer system (76, 77; 87) has at least two buffer stations for the temporary storage of load carriers (2) laden with luggage and the buffer system (76, 77; 87) is designed for re-sorting the load carriers (2) laden with luggage.

5. The security inspection system according to claim 3, characterized in that the buffer system (76, 77; 87) is designed for re-sorting the load carriers (2) by displacement in at least two different, in particular orthogonal, axial directions.

6. The security inspection system according to claim 1, characterized in that in the luggage drop-off region (1) at each drop-off station (1a, 1b, 1c) a first identification device (10) is provided for detecting a personal identifier of the person, which interacts with a data processing device (11) for linking the personal identifier of the person with the load carrier (2) in which the person's luggage is located.

7. The security inspection system according to claim 6, characterized in that the at least one follow-up inspection station (70, 71) is equipped with a third identification device (78) for detecting the personal identifier of the person standing at the follow-up inspection station (70, 71), wherein the third identification device (78) is linked to the transfer system (74, 75) in order to transfer the load carrier (2) linked to the personal identifier of the person to this follow-up inspection station (70, 71).

8. The security inspection system according to claim 3, characterized in that the follow-up inspection region (7) has at least two follow-up inspection stations (70, 71), each with at least one associated removal station (72, 73), and the transfer system (74, 75) is designed to transfer load carriers (2) laden with luggage from the buffer system (76, 77; 87) to the at least two follow-up inspection stations (70, 71).

9. The security inspection system according to claim 2, characterized in that the follow-up inspection station (70, 71) for providing the load carrier (2) with the luggage objected to is arranged between the first and the second sojourn location (M1, P1; M2, P3) and furthermore a transparent security partition (79) is provided between the provided load carrier (2) and the second sojourn location (M1, P1; M2, P3).

10. The security inspection system according to claim 1, characterized in that the follow-up inspection region (7) has at least one waiting area (80) for persons whose luggage was objected to in the luggage inspection station (3).

11. The security inspection system according to claim 1, characterized in that at each removal station (72, 73) at least one monitoring device (83) is provided for detecting a load carrier (2) that is not completely emptied and/or is soiled.

12. The security inspection system according to claim 1, characterized in that input and/or output units are provided at each removal station, which are designed to provide information to the person and/or to terminate the emptying process of the load carrier by the person.

13. The security inspection system according to claim 1, characterized in that a sensor unit, which is formed for example by the fourth identification device (82), is provided at each removal station (72, 73), which unit is designed to determine the presence of a person located at the removal station (72, 73) and which is linked to the monitoring device (83) and the transfer system (74, 75) in such a way that the emptying process is completed by removing the emptied load carrier (2) if the sensor unit does not detect a person in front of the removal station (72, 73) and the load carrier is empty.

14. The security inspection system according to claim 1, characterized in that the follow-up inspection region (7) is arranged adjacent to the luggage pick-up region (6) and at least one removal station (72, 73)—depending on the number of persons in the follow-up inspection region (7) and in the luggage pick-up region (6)—functions as a removal point (72, 73) or as a removal station (6a, 6b, 6c).

15. A security inspection method, characterized in that
a person in a luggage drop-off region (1) with one or more drop-off stations (1a, 1b, 1c) drops off his or her luggage in a load carrier (2) provided at a drop-off station (1a, 1b, 1c),
the luggage is subjected to an imaging examination at a luggage inspection station (3),
the person collects his/her luggage in a luggage pick-up region (6), provided that the luggage was not objected to at the luggage inspection station,
the person goes to a follow-up inspection region (7) with at least one follow-up inspection station (70, 71) accessible from two sides for manual follow-up inspection, if the luggage was objected to at the luggage inspection station (3), wherein the follow-up inspection station (70, 71) is accessible on one side by an employee of the security inspection system and on the other side by the person to whom the luggage objected to belongs,
the load carriers (2) laden with luggage are transported from the luggage drop-off region (1) via the luggage inspection station (3) to the luggage pick-up region (6) or to the follow-up inspection region (7) and empty load carriers (2) are transported back to the luggage drop-off region (1),
characterized in that
after the manual inspection of the luggage, the person goes from the follow-up inspection station (70, 71) to an assigned removal station (72, 73) to empty the load carrier (2),
the person's load carrier (2) laden with luggage is transferred from the follow-up inspection station (70, 71) to the assigned removal station (72, 73), wherein the transfer of a new load carrier (2) laden with luggage to the follow-up inspection station (70, 71) takes place irrespective of whether the assigned removal station (72, 73) is occupied with a load carrier (2).

16. The security inspection method according to claim 15, characterized in that at each drop-off station (1a, 1b, 1c) a personal identifier of the person is detected by means of a first identification device (10) and the personal identifier of the person is linked by means of a data processing device (11) to the load carrier (2) in which the person's luggage is located.

17. The security inspection method according to claim 16, characterized in that at each follow-up inspection station (70, 71) the personal identifier of the person is detected by means of a third identification device (78) and then the load carrier (2) linked to the person is made available at the follow-up inspection station (70, 71).

18. The security inspection method according to claim 17, characterized in that at each removal station (72, 73) the personal identifier of the person is detected by means of a fourth identification device (82) and the load carrier (2) linked to the person is transferred from the follow-up inspection station (70, 71) to the removal station (72, 73).

19. The security inspection method according to claim 18, characterized in that the emptying process of the load carrier (2) at the removal station (72, 73) is automatically terminated and the load carrier (2) is transported away, in that a monitoring unit (83) detects an empty load carrier (2) and a sensor unit is formed, determines that no person is present at the removal station (72, 73).
